(19) United States
(12) Patent Application Publication
(10) Pub. No.: US 2018/0166897 A1
(43) Pub. Date: Jun. 14, 2018

(54) Multi-functional Waterproof Power Bank

(71) Applicant: Xiuhong DENG, Shenzhen (CN)

(72) Inventor: Xiuhong DENG, Shenzhen (CN)

(21) Appl. No.: 15/376,673

(22) Filed: Dec. 13, 2016

(51) Int. Cl. H02J 7/00

(52) U.S. Cl. CPC H02J 7/0044

(57) ABSTRACT

A multi-functional waterproof power bank is disclosed. Charging interfaces, including an iOS system mobile phone charging interface, an android system mobile phone charging interface, a USB-A interface and a Type-C interface, are formed at the middle portion of the right end of a main body; a protective sheath is sleeved on the main body to close off the left end of the main body; and a hollowed end cap is fastened to the right end of the main body to expose the charging interfaces. A flip cover is installed on one side of the hollowed end cap. A DC jack is formed at the right end of the main body; a waterproof DC receptacle is inserted into the DC jack. The waterproof DC receptacle is formed with screw threads on the inner wall. A DC plug is screwed into the DC receptacle and is plugged into the DC jack.

### BACKGROUND OF THE INVENTION

The invention relates to the technical field of charging devices, in particular to a multi-functional waterproof power bank.

Existing mobile power banks only have simple charging functions for a single purpose, and are inconvenient and inefficient when used outdoors, and when being used under water or caught in the rain, are easily invaded by water and damaged. The power banks have poor waterproof performance.

### BRIEF SUMMARY OF THE INVENTION

Aiming at defects in the prior art, the invention provides a multi-functional waterproof power bank.

To achieve the above objectives, the invention provides a multi-functional waterproof power bank, including a main body, wherein a plurality of charging interfaces are formed at the middle portion of the right end of the main body; a protective sheath is sleeved on the main body to close off the left end of the main body; a hollowed end cap is fastened to the right end of the main body to expose the plurality of charging interfaces;

wherein the plurality of charging interfaces include an iOS system mobile charging interface, an android system mobile phone charging interface, a USB-A interface and a Type-C interface; a flip cover is installed on one side of the hollowed end cap, and is opened when the plurality of charging interfaces are used;

wherein a DC jack is formed at the right end of the main body; a waterproof receptacle is inserted in the DC jack; the waterproof receptacle is formed with screw threads on the inner wall; and the DC plug is screwed into the waterproof DC receptacle and is plugged into the DC jack.

In the multi-functional waterproof power bank, preferably, a hook hole is formed at one end of the protective sheath, and a mountaineering hook made of aluminum alloy is hooked in the hook hole.

In the multi-functional waterproof power bank, preferably, the protective sheath is formed with a plurality of hollows.

In the multi-functional waterproof power bank, preferably, the outer wall of the DC plug is formed with external screw threads which match with the internal screw threads.

In the multi-functional waterproof power bank, preferably, an LED light is installed at the right end of the main body.

In the above technical solution, the multi-functional waterproof power bank provided by the invention, compared with the prior art, can charge a plurality of devices at the same time by configuration of a plurality of charging interfaces, and through the elastic hook hole, can receive the hook in the hook hole to facilitate mountaineering; the interfaces undergo waterproof treatment through plastic wrapping, glue application and silica gel compression; the structure is simple; the appearance is beautiful and elegant.

### BRIEF DESCRIPTION OF THE DRAWINGS

FIG. 1 is a structural view of a multi-functional waterproof power bank in an embodiment of the invention.

FIG. 2 is a front view of a multi-functional waterproof power bank in an embodiment of the invention.

FIG. 3 is a right top view of a multi-functional waterproof power bank in an embodiment of the invention.

### DETAILED DESCRIPTION OF THE INVENTION

### Embodiment 1

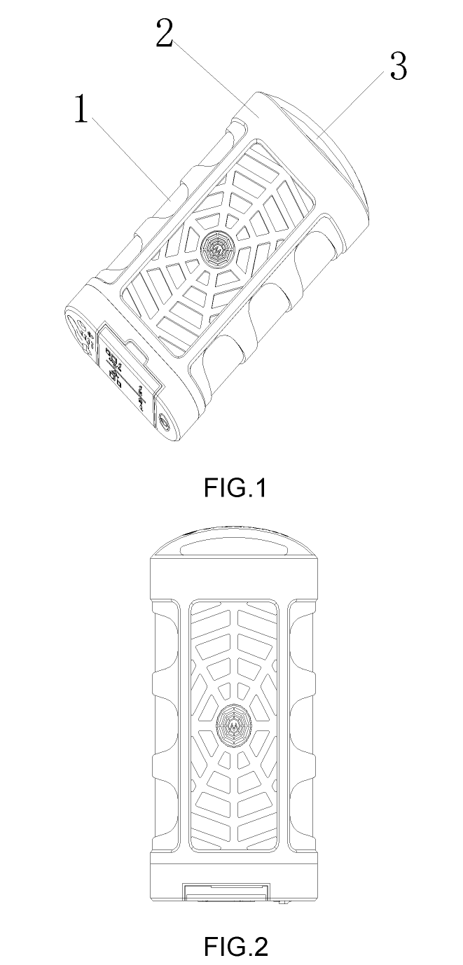

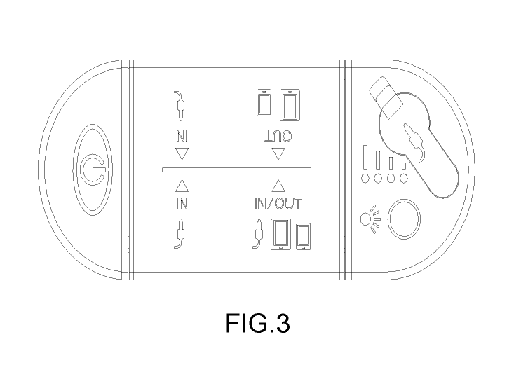

As shown in FIGS. 1-3, a multi-functional waterproof power bank includes a main body 1, wherein a plurality of charging interfaces are formed at the middle portion of the right end of the main body 1; a protective sheath 2 is sleeved on the main body 1 to close off the left end of the main body 1; and a hollowed end cap is fastened to the right end of the main body 1 to expose the plurality of charging interfaces. The plurality of charging interfaces include an iOS system mobile charging interface, an android system mobile phone charging interface, a USB-A interface and a Type-C interface; and a flip cover is installed on one side of the hollowed end cap, and is opened when the plurality of charging interfaces are used. A DC jack is formed at the right end of the main body 1; a waterproof DC receptacle is inserted in the DC jack; the waterproof receptacle is formed with screw threads on the inner wall; and the DC plug is screwed into the waterproof DC receptacle and is plugged into the DC jack. A hook hole is formed at one end of the protective sheath 2, and a mountaineering hook made of aluminum alloy is hooked in the hook hole. The protective sheath 2 is formed with a plurality of hollows. the outer wall of the DC plug is formed with external screw threads matched with the internal screw threads. An LED light is installed at the right end of the main body 1. The seams of the joints between the plurality of charging interfaces and the main body 1 are waterproofed by means of bicolor die processing plastic wrapping, glue application and silica gel compression. The structure is simple. The use is convenient and efficient. The appearance is beautiful and elegant.

The product's hook is a mountaineering hook made of aluminum alloy. Due to the multi-functional combination mode and the practicability, the hook can hook objects with a large weight. 2m Anti-collision function: the product housing is made by injection molding of PC materials, together with TPU plastic, capable of buffering high-strength impact, realizing double protection against collision, and also bettering the hand feel. 10m Military waterproof rating: the charging interfaces of the product are waterproofed by means of plastic wrapping, glue application and silica gel compression, which is simple, convenient, waterproof, and firm. Charging with deep diving: the product can provide power supply underwater; the product is made of a special waterproof DC receptacle, and the charging plug is fixed at the power bank and the mobile phone by screw locking, achieving the function of deep diving. The operation is simple and the charging plug is firmly fastened. No matter whether it is the sea bed or in rivers, charging under water can be simple and easily carried out in any water environment. Diving light: A high-brightness LED light is adopted, tightly installed at the power bank, capable of lighting for deep diving and providing normal light illumination at any time anywhere. The operation is simple and the LED light is firmly installed. Multi-functional rapid charging: the product integrates SAMSUNG interfaces, interfaces for Apple products, a Type-C interface, USB-A QC2.0/3.0 smart charging identification interface, capable of rapidly charging electronic products of different specifications. The flip cover is adopted to protect the interfaces, achieving the waterproof and dust-proof effects. The operation is convenient, and the appearance is not affected.

The above embodiments are only preferably embodiments of the invention and shall not be regarded as limit of the invention. For those skilled in the art, various changes and modifications can be made on the invention. Any modifications, equivalent changes and improvement made within the spirit and principle of the invention shall fall within the protective scope of the invention.

What is claimed is:

1. A multi-functional waterproof power bank, characterized by comprising a main body, wherein a plurality of charging interfaces are formed at the middle portion of the right end of the main body; a protective sheath is sleeved on the main body to close off the left end of the main body; a hollowed end cap is fastened to the right end of the main body to expose the plurality of charging interfaces;
wherein the plurality of charging interfaces include an iOS system mobile charging interface, an android system mobile phone charging interface, a USB-A interface and a Type-C interface; a flip cover is installed on one side of the hollowed end cap, and is opened when the plurality of charging interfaces are used;
wherein a DC jack is formed at the right end of the main body; a waterproof receptacle is inserted in the DC jack; the waterproof receptacle is formed with screw threads on the inner wall; and the DC plug is screwed into the waterproof DC receptacle and is plugged into the DC jack.

2. The multi-functional waterproof power bank according to claim 1, wherein a hook hole is formed at one end of the protective sheath, and a mountaineering hook made of aluminum alloy is hooked in the hook hole.

3. The multi-functional waterproof power bank according to claim 2, wherein the protective sheath is formed with a plurality of hollows.

4. The multi-functional waterproof power bank according to claim 1, wherein the outer wall of the DC plug is formed with external screw threads which match with the internal screw threads.

5. The multi-functional waterproof power bank according to claim 1, wherein an LED light is installed at the right end of the main body.
